(19) United States
(12) Patent Application Publication
(10) Pub. No.: US 2014/0176328 A1
(43) Pub. Date: Jun. 26, 2014

(54) Passenger Management system

(71) Applicant: Kadari SubbaRao Sudeendra Thirtha Koushik, Bangalore (IN)

(72) Inventor: Kadari SubbaRao Sudeendra Thirtha Koushik, Bangalore (IN)

(21) Appl. No.: 13/723,234

(22) Filed: Dec. 21, 2012

(51) Int. Cl. G08B 23/00

(52) U.S. Cl. CPC G08B 23/00
USPC 340/539.13

(57) ABSTRACT

A system and method for passenger/user management in an environment is disclosed. The system provides tag enabled material to the passengers and multiple readers are located in the environment to track the location of the passengers within the environment. The reader communicates the tracked location to the management device in the environment. The system provides a simple and efficient way to track passengers within an airport terminal and on-board. The system offers better airport operations and passenger experience and provides cost savings to airlines due to reduced number of flight delays. The management device tracks the passengers using Wi-Fi, GSM, Personal Address, Displays to provide alert to the passenger for any services.

The present application is based on, and claims priority from, IN Application Number 5057/CHE/2012, filed on 4 Dec. 2012, the disclosure of which is hereby incorporated by reference herein.

### TECHNICAL FIELD

The embodiments herein relate to user (passenger) management system and more particularly relates to tracking the location of users in an environment.

### BACKGROUND

Passenger management and their movement in airports, train stations, bus stations require an increasing amount of resources. Some large airports have a throughput of several million passengers per year. In airports, delays due to late arrival of checked in passengers at boarding gates, costs a lot to the airlines in terms of time, airport terminal costs and brand equity and also to passengers in terms of inconvenience and missed connecting flights. Presently, the airlines depend on the public address system inside the airport terminal to reach out to such passengers which is not very reliable. Once onboard the aircraft, it is imperative to track the movements of passengers. Currently, there are no mechanisms to track passenger movements which can be real critical piece of evidence in certain situations as accidents, sabotage or terrorist activities.

In airport terminal, some of the problems arise in tracking passengers in order to locate passengers who have checked in and localize them to specific areas or zones inside the terminal. Also, the location, area or zone based passenger density sensitization helps the airport managers to react quickly to situations of clogging, queues. This often helps to mobilize passengers by an airline staff to move them to boarding gates or for other purposes. When it comes to international travel, the boarding aircraft will reach the destination with a stopover in some airport in between. In this scenario, the passenger has to be manually asked to leave the aircraft which is very time consuming and inefficient.

Currently, the above problems are solved with public address system which is very ineffective. This often leads delays to flights and customer heart burn. Airport managers have a more crude visual method of identifying busy or dense areas within the terminal and often their remedial actions are reactive and not proactive. Also, airline staff has to manually check with passengers for their boarding cards if they need to track their passenger, which is impractical in modern, big airports and very expensive for the airline company to implement. Currently there is no automatic system is available for tracking on-board passengers and passengers in aircraft during stopover.

The conventional system does not solve the abovementioned problems in bus station, train stations, shopping areas. In shopping areas, the authority can count the number of users in a particular time and provide them with value-added services and operate one or more elevators, escalators and so on.

In light of above discussion, the existing system of passenger or user tracking fails to address the delay caused by the passenger and also in on-board aircraft count the passengers to prevent any accidents, sabotage or terrorist activities.

### BRIEF DESCRIPTION OF THE FIGURES

The embodiments herein will be better understood from the following detailed description with reference to the drawings, in which:

FIG. 1 illustrates an overview of tracking users in an environment, according to the embodiments disclosed herein;

FIG. 2 illustrates an exemplary user tracking system in the environment, according to the embodiments disclosed herein;

FIG. 3 illustrates the exemplary passenger tracking system in an airport, according to embodiments disclosed herein;

FIG. 4 illustrates the overview of tracking passengers in airport and in aircraft, according to embodiments disclosed herein;

FIG. 5 illustrates the flow diagram explaining the process of tracking passengers in airport and on-board aircraft, according to embodiments disclosed herein; and

FIG. 6 illustrates the computing environment implementing the passenger management system, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a system and method to track the passengers in an environment and minimize the delay caused by the passengers in boarding the transport in the environment. The system can be implemented in the airport to quickly find out the density of passengers in real-time in various pre-marked zones within the terminal. This information can help take remedial actions like opening extra counters, doors for passage or any such action that allows easier movement. This way the passenger handling can be made efficient and customer satisfaction increases, thus enhancing brand equity of airport terminals.

At the boarding gate in the airport, the system allows an efficient counter check of the count of passengers who have moved into the aero bridge or towards the aircraft. Also, the boarding gate can get a feedback which part of the aircraft is denser with passengers and hence the boarding sequence can be managed.

When passenger gets on-board the aircraft the identification of seats is the first step. By using the proposed system the passengers can be confirmed of the seats identified with an audio and/or visual signal or by another means of message to the hand held device of the passenger.

Special flights with stopover (transit) can help improve their efficiency in tracking passengers who is exiting in the aircraft, who is entering the aircraft and who is left behind. This proposed system makes the process faster and more accurate. This is critical during international transfers where immigration and visa is involved.

In an embodiment, the environment comprises airport, aircraft, bus stations, train stations, shopping areas, departmental store or the like.

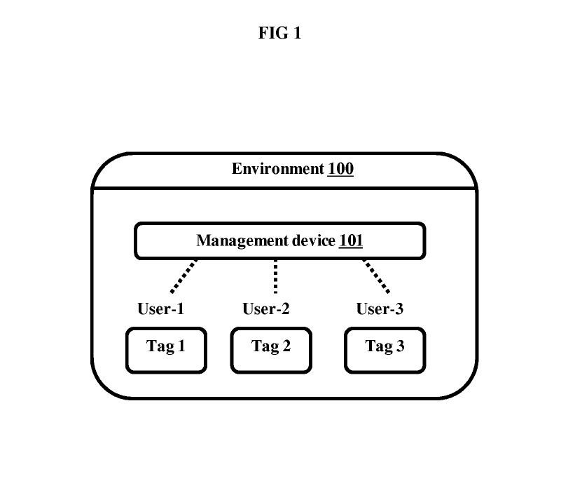

FIG. 1 illustrates an overview of tracking users in an environment, according to the embodiments disclosed herein. The figure depicts an environment 100 which comprises a management device 101 and plurality of tags such as tag 1, tag 2, tag 3 associated with user-1, user-2 and user-3 moving around the environment.

The management device 101 in the environment tracks the location of the users using the tag information. Initially, the tag is configured to store information about the user. In an embodiment, the information comprises location of users, a unique identifier of the users; boarding details of the users, travel itinerary, other personal details.

In an embodiment, the location of users is tracked using GPS chip embedded in the tag.

In an embodiment, the tag can be a Radio Frequency Identification (RFID), Near Field Communication (NFC), Bluetooth or the like.

For example, in case of shopping area, plurality of users enters the shopping area and they will be given a tag. In an embodiment, the tag can be attached to the information card that comprises the shops in the shopping area, promotional card, gift coupon card or the like. In such a scenario, the number of users is tracked by the management device 101 in the shopping area using the tag and provides services. In an embodiment, the services comprise operating additional lifts, elevators, escalators, advertising, fire safety or the like.

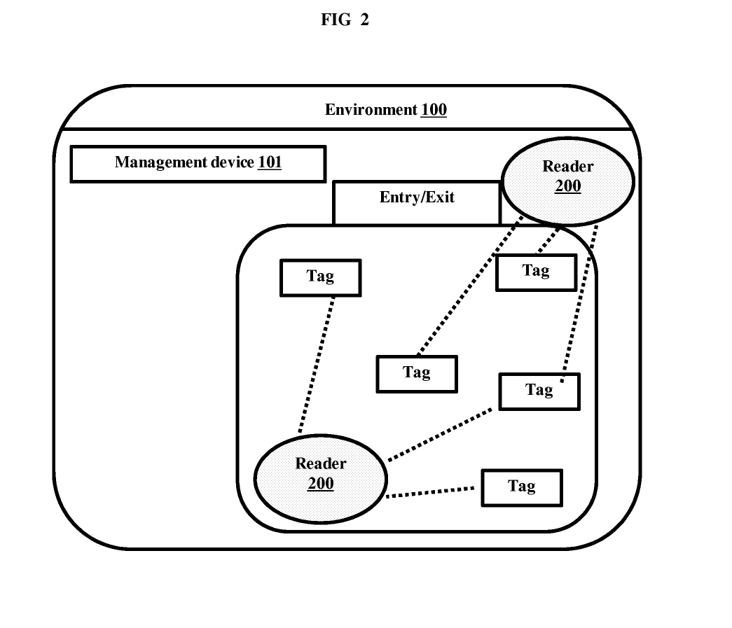

FIG. 2 illustrates an exemplary user tracking system in the environment, according to the embodiments disclosed herein. The figure depicts the environment 100, the management device 101, a reader 200 installed in multiple places/zones in the environment. In an embodiment, the reader 200 can be a RFID reader, Bluetooth reader, NFC reader capable of reading the reading the information in the tag. The reader 200 communicates the user location or position in the environment to the management device 101 and the management device 101 allows the personal to provide to provide services to the users in the environment.

For example, in the bus station environment, the passengers are given a tag attached to the boarding pass. Then the passengers may move around the environment. In this scenario, when the bus authority wants to track the passengers within the environment 100, there are multiple readers 200 placed in and around the environment 100. There is a reader 200 located in the entry and exit points of the bus station and there can be a reader placed inside the bus station. Whenever, passengers pass by the reader 200, the reader reads the tag and send the tracked information to the management device 101. In an embodiment, the management device 101 provides graphical user interface (GUI) to the authority to track the location of the passengers and provide services.

In an embodiment, when the passenger is making a delay in boarding the bus. Then the management device 101 with the help of reader 200 tracks the location of passenger in the environment 100 and send messages, alerts to the passenger to board the bus.

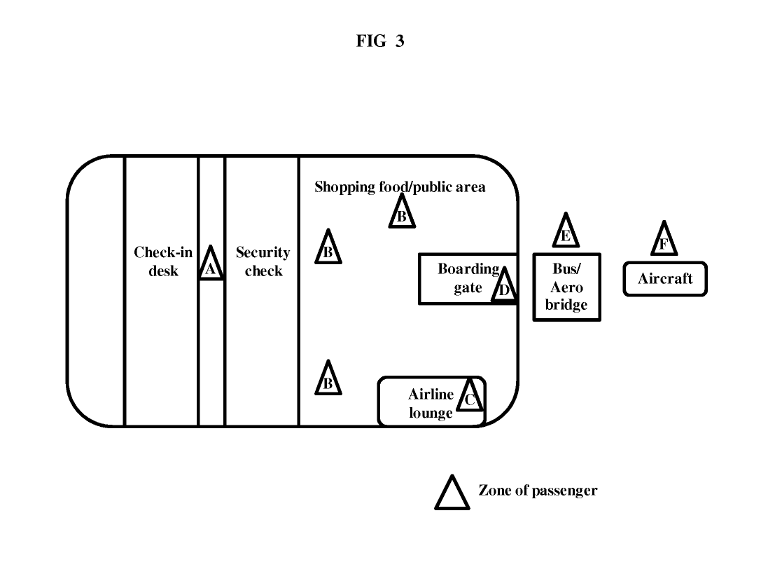

FIG. 3 illustrates the exemplary passenger tracking system in an airport, according to embodiments disclosed herein. The figure depicts an overview of a typical airport environment. The airport terminal is divided into zones and sub-zones. Zone comprises a check-in desk, followed by a security check counter. After the security check there is shopping area, public area, airport lounge, a boarding gate. Then an aero bridge is used to connect the boarding gate to the aircraft. At times, buses are also used to commute the passengers from boarding gate to the aircraft.

When the passengers enter the airport, a tag is issued to the passenger. The tag enabled boarding passes, frequent flyers cards or an add-on sticker is issued at check-in desk. The tag comprises unique information about the passenger such as PNR number, date of journey, airline name, boarding details or the like.

Based on the various geo-tag readers placed in different zones of the airport, the passengers can be tracked to a particular ‘zone’ within the airport terminal. The tag input is mapped to the corresponding passenger or person and can be tagged as passenger, employee or the like. A management device 101 combines this information along with a graphical user interface and communication channel to various devices, allows the airport manager to visually map the zones with the density of people or passengers or employees. This will enable them to react to building queues or denser zones for example to open additional pathways or operate the lifts and elevators efficiently.

The zone based view of passengers can be integrated with the airline systems so that the airline staff can then monitor, if these passengers, based on their current locations will reach their boarding gates on time based on the distance from their current position to the boarding gate. This will also allow the airline staff to pin point the location where the passengers are in case they are delaying a flight and hence can mobilize them from that location.

Whenever the passenger is making delay to board the aircraft and if the detected passenger has a registered mobile number the management device 101 is configured to give a call or message to inform and mobilize the passenger towards the terminal.

Once the passenger is detected in a zone the airline agent or staff can approach that passenger to move to the boarding gate.

In some cases a local display can show the message on screen when the passenger is shopping in a particular shop in the airport lounge.

In an embodiment, the passengers are informed about their delays using corresponding displays in the air lounges and shops where the passenger is located.

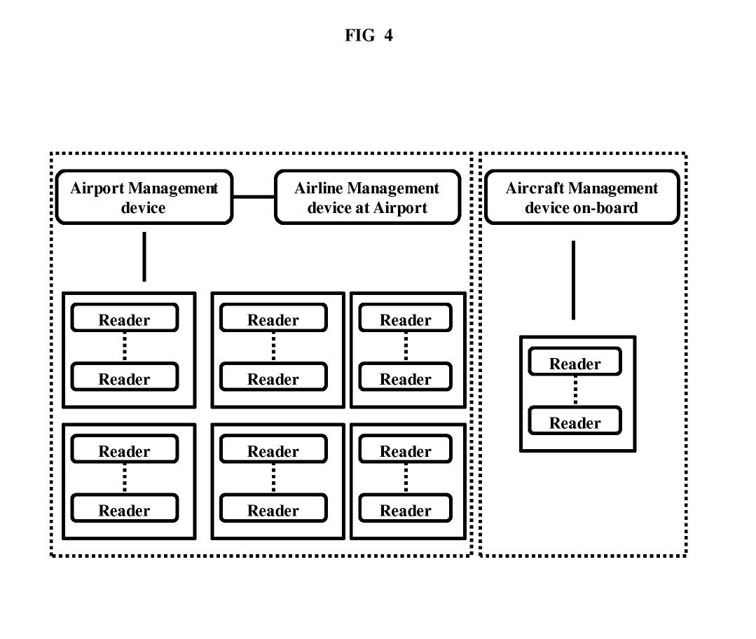

FIG. 4 illustrates the overview of tracking passengers in airport and in aircraft, according to embodiments disclosed herein. The figure depicts a schematic representation of implementing the embodiment in the airport and aircraft environment. In the airport environment there is an airport management device 101 which tracks the location or position of the passengers using multiple reader placed in different zones of the airport. The proposed system track passengers on a zone basis within the airport terminal. These zones are scalable to increase or decrease the area per zone or the total terminal can be expanded. At the boarding gate the system allows an efficient counter check of the count of passengers who have moved in to the aero bridge or towards the aircraft. Also the boarding gate can get a feedback which part of the aircraft is denser with passengers and hence the boarding sequence can be managed.

The figure also depicts an airline management device 101 which gets the exact location of passengers they want to trace within the airport terminal. Passengers can be notified in multiple ways to increase the chances of getting their attention and hence avoid delays and associated costs. If there is a delay by a passenger, the airline management device 101 tracks the location of the passenger in the zone and the management device 101 calculates the distance from the tracked location to the aero bridge in order to board the aircraft. This even helps the airline staff to reach the passenger and mobilize the passengers towards the aero bridge. By this airline receives better brand image due to better services and on time departures.

The figure also depicts an aircraft management device on-board. The readers can be present within the management device or near the seats in the aircraft. When a passenger gets on-board, the identification of seats is the first step. By using the proposed system the passengers can be confirmed of the seats identified with an audio and/or visual signal or by another means of message such as Bluetooth based communication to the hand held device of the passenger.

During the course of air travel, the movement of passengers within the aircraft can be tracked by the aircraft management device on-board. This information can be critical during special cases as sabotage or terrorism based attacks. Even during accidents people can be tracked as to where they were at given points of time. This can serve as a passenger side black box.

In an embodiment, in case of special flights with stopover improves their efficiency in tracking who is exiting the aircraft, who is entering the aircraft and who is left behind.

For example, when a passenger wants to travel Munich from New York. The aircraft in which the passenger travels will reach the destination Munich through Dubai (transit). There can be some passengers in the aircraft who have to get down at Dubai. In the case, the aircraft management device through the reader tracks the tag information of all the passengers and easily identifies the destination place of the passengers. This helps to know the passengers who are suppose to get down at Dubai and passengers who should stay in the same aircraft to reach Munich.

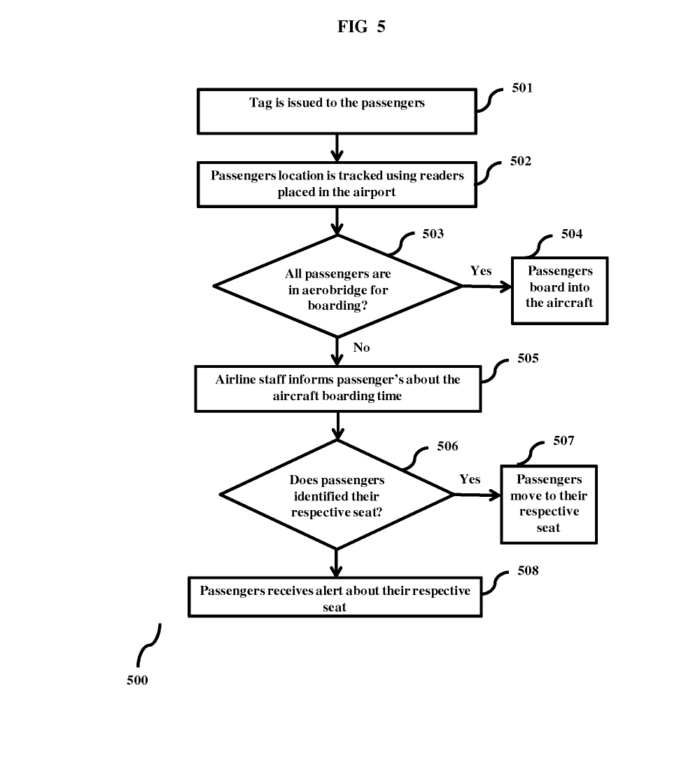

FIG. 5 illustrates the flow diagram explaining the process of tracking passengers in airport and on-board aircraft, according to embodiments disclosed herein. As depicted in the flow diagram 500, initially at the check-in desk the tag is issued (501) to the passengers. The tag can be attached to the boarding pass, travel itinerary or the like. Now, the movement of the passengers in the airport is tracked (502) using the readers placed in different zones of the airport and communicated to the management device 101 located either in the airport or airline environment. Further, the airline staff checks (503) whether all the passengers of the particular aircraft are ready to board is in the aerobridge. This is detected using the reader placed in the aerobridge and the reader communicates this to the airline management device. Once the airline staff knows that all the passengers are in the aerobridge, then all the passengers are boarded (504) into the aircraft. If the airline staff finds that one or more passengers are not in the aero-bridge, then the airline staff informs (505) the one or more passengers about the boarding time. From the airline management device 101 the airline staff also knows the distance from the location of the passenger to the aero bridge. In this case, the airline staff can move to the passenger and mobilize the passenger to the aerobridge. The information (alert) may be sent to the passengers in several means.

In an embodiment, the alert can be sent to the passenger mobile number, audio alert, and visual alert in the display held by shops in airline lounge or the like.

After the passengers board onto the aircraft, the first step is to find their respective seat. The management device 101 on-board checks (506) whether the passenger identified their respective seat. If the passenger identifies their respective seat, then they move (507) to their respective seat. If the passenger did not identify their respective seat then an alert is sent (508) from the management device 101 on-board to the passenger mobile device about the seat. During ticket booking, if the passenger registers his/her mobile number with the airline, then an audio alert informing the direction to reach their respective seat, or the visual alert is sent to the passenger mobile device. The various actions in method 500 may be performed in the order presented, in a different order or simultaneously. Further, in some embodiments, some actions listed in FIG. 5 may be omitted.

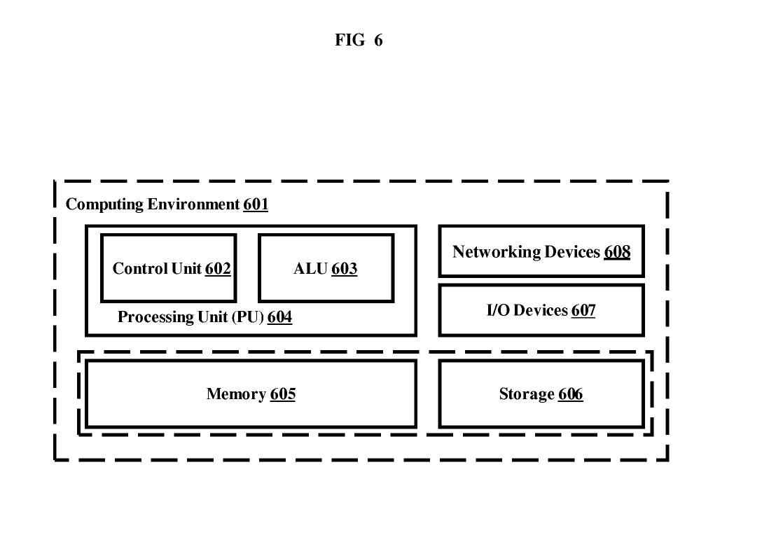

FIG. 6 illustrates the computing environment implementing the passenger management system, according to embodiments disclosed herein. As depicted the computing environment 601 comprises at least one processing unit 604 that is equipped with a control unit 602 and an Arithmetic Logic Unit (ALU) 603, a memory 605, a storage unit 606, plurality of networking devices 708 and a plurality Input output (I/O) devices 607. The processing unit 604 is responsible for processing the instructions of the algorithm. The processing unit 604 receives commands from the control unit in order to perform its processing. Further, any logical and arithmetic operations involved in the execution of the instructions are computed with the help of the ALU 603.

The overall computing environment 601 can be composed of multiple homogeneous and/or heterogeneous cores, multiple CPUs of different kinds, special media and other accelerators. The processing unit 604 is responsible for processing the instructions of the algorithm. Further, the plurality of processing units 704 may be located on a single chip or over multiple chips.

The algorithm comprising of instructions and codes required for the implementation are stored in either the memory unit 605 or the storage 606 or both. At the time of execution, the instructions may be fetched from the corresponding memory 605 and/or storage 606, and executed by the processing unit 604.

In case of any hardware implementations various networking devices 608 or external I/O devices 607 may be connected to the computing environment to support the implementation through the networking unit and the I/O device unit.

The embodiments disclosed herein can be implemented through at least one software program running on at least one hardware device and performing network management functions to control the network elements. The network elements shown in FIGS. 1, 2, 4 and 6 include blocks which can be at least one of a hardware device, or a combination of hardware device and software module.

The embodiment disclosed herein specifies a system and method for user/passenger management in an environment. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A system for managing one or more users in an environment, wherein said system comprises:
a tag configured to include information about said one or more users;
a management device configured to:
track said information of said one or more users with said tag;
use said information to perform one or more activities, wherein said one or more activities comprises counting said one or more users in said environment; and
provide alert to said one or more users based on said one or more activities.

2. The system as in claim 1, wherein said one or more activities further comprises at least one of: calculating distance of said one or more users from one or more points of said environment to determine the delay made by said one or more users in reaching said environment, identifying seat of said one or more users in said environment, monitoring movement of said one or more users in said environment.

3. The system as in claim 2, wherein said environment comprises at least one of: airport, aircraft, bus stations, train stations, shopping areas, departmental store.

4. The system as in claim 3, wherein said management device is configured to track said information of said one or more users with said tag using a reader, wherein said information comprises: location of said one or more users, a unique identifier of said one or more user, boarding details of said environment, travel itinerary, other personal details of said one or more users.

5. The system as in claim 1, wherein said management device is configured to visually map said location in said environment and provide services, wherein said services comprises at least one of: pathways, lifts, escalators.

6. The system as in claim 2, wherein said management device is configured to provide alert to said one or more users in said environment using at least one of: display, audio signal, video signal to notify said one or more users about said seat, said delay.

7. The system as in claim 6, wherein said management device is configured to provide alert to a wireless device with said one or more users.

8. The system as in claim 3, wherein said management device is implemented as an on-board device in said aircraft and configured to identify said seat of said one or more users using said information in said tag.

9. A method for managing one or more users in an environment, wherein said method comprises:
including information of said one or more users in a tag;
tracking said information of said one or more users with said tag;
using said information to perform one or more activities, wherein said one or more activities comprises counting said one or more users in said environment; and
providing alert to said one or more users based on said one or more activities.

10. The method as in claim 9, wherein said one or more activities further comprises at least one of: calculating distance of said one or more users from one or more points of said environment to determine the delay made by said one or more users in reaching said environment, identifying seat of said one or more users in said environment, monitoring movement of said one or more users in said environment.

11. The method as in claim 10, wherein said environment comprises at least one of: airport, aircraft, bus stations, train stations, shopping areas, departmental store.

12. The method as in claim 11, wherein said method tracks said information of said one or more users with said tag using a reader, wherein said information comprises: location of said one or more users, a unique identifier of said one or more users, boarding details of said environment, travel itinerary, other personal details of said one or more users.

13. The method as in claim 9, wherein said method further comprises visually mapping said location in said environment and provide services, wherein said services comprises at least one of: pathways, lifts, escalators.

14. The method as in claim 10, wherein said method provides alert to said one or more users in said environment using at least one of: display, audio signal, video signal to notify said one or more users about said seat, said delay.

15. The method as in claim 14, wherein said method provides alert to a wireless device with said one or more users.

16. The method as in claim 11, wherein said method comprises an on-board device in said aircraft and configured to identify said seat of said one or more users using said information in said tag.
